(19) United States
(12) Patent Application Publication
(10) Pub. No.: US 2014/0119635 A1
(43) Pub. Date: May 1, 2014

(54) Emission Curve Tracer Imaging

(71) Applicant: ENTROPIC COMMUNICATIONS, INC, San Diego, CA (US)

(72) Inventor: Joseph M. Patterson, Carlsbad, CA (US)

(73) Assignee: ENTROPIC COMMUNICATIONS, INC, San Diego, CA (US)

(21) Appl. No.: 13/686,850

(22) Filed: Nov. 27, 2012

Related U.S. Application Data
(60) Provisional application No. 61/721,429, filed on Nov. 1, 2012.

(51) Int. Cl. G06T 7/00

(52) U.S. Cl. CPC G06T 7/0002
USPC 382/147

(57) ABSTRACT

An apparatus, a method, and a computer-program product for identifying a location of abnormal emission on integrated circuits are disclosed. The location of abnormal emission on integrated circuits is identified by measuring an emission intensity for each of a plurality of voltages for each pixel in an emission image of an integrated circuit; generating a plot of the measured emission intensities as a function of the plurality of voltages for each area in the emission image of the integrated circuit; determining differences in emission intensities of the generated plot for a selected area compared to a plot for a corresponding area known to have no abnormal emission; and identifying location of abnormal emission corresponding to the selected area the detected difference of which exceeds a pre-determined threshold.

### CROSS REFERENCE TO RELATED APPLICATIONS

This application claims the benefit of U.S. provisional patent application No. 61/721,429 filed Nov. 1, 2012, which is incorporated herein by reference in its entirety.

### BACKGROUND

1. Field

The present invention relates generally to emission analysis, and more specifically to identification location(s) of abnormal emission on integrated circuits.

2. Background

With the increasing complexity and associated density of integrated circuits (IC), there is a need to identify defect(s) and location(s) of such defect(s) on the ICs. One of the approaches is observing a current flowing through different locations on the IC in response to the voltage applied to the IC. If a current at a particular location of the IC under test exhibits a value exceeding a threshold, such a condition may be an indication of a defect. The threshold may be determined by, e.g., observing current value at a corresponding location on an IC considered without defects.

Although in general it is possible to sense the current via sensor physically touching the particular location of an IC, several vendors provide equipment with remote sensor. The function of the equipment with remote sensor is based on the fact that the current demonstrates itself as an emission from the IC; the intensity of the emission at a particular location being proportional to the current at a particular location and the voltage applied to the IC. Such an intensity of emission can be captured by the remote sensor operating in the spectrum of the emission. The equipment may comprise a plurality of remote sensors; each of the plurality of remote sensors working in a different part of the emission spectrum.

By means of an example, one remote sensor may capture near-infrared emission, i.e., emission a spectrum of which is characterized with wavelength less than 800 μm, another sensor may capture the rest of the infrared emission spectrum, and yet another sensor may capture emissions in the optical spectrum.

Consider the operation of the equipment with the near-infrared or the infrared sensor, summarily referred to as infrared (IR) sensor, as currently implemented in the art. The IR sensor is activated and a pre-selected voltage, e.g., specified supply voltage, is applied to the IC. The IR sensor captures the changing images of the intensity of the IR emission as a function of time, as the IC heats up after the application of the pre-selected voltage. After the temperature reaches equilibrium, thus the movie, i.e., the set of the images in time, is completed and stored; an imaging process selects a picture element (pixel) on the captured images corresponding to a location on the IC and generates a plot of the intensity of the IR emission, i.e., temperature versus time, for that pixel. Abnormal changes in the intensity of the IR emission at a given location of the IC under test as compared to a corresponding location of an IC considered without defects can indicate a defect.

The term pixel as used herein is to be understood as the smallest distinguishable element representing an area in the picture, and depends on the sensor's technology.

Interestingly, as currently implemented in the available equipment, the operation of an optical sensor is different. After an optical sensor is activated, a pre-selected voltage is applied to the IC and the optical sensor captures a static picture of the IC reflecting the intensity of the optical emission. An imaging process selects a picture element (pixel) on the captured image corresponding to a location on the IC and maps the intensity of the optical emission at the pixel on a color pallet by dividing the observed intensity of emission into discrete intervals (bins), and assigning a different color to each of the bins. The operator of the equipment may then compare the colors at corresponding location of a picture taken on the IC under test and on an IC considered without defects; wherein abnormal changes in the intensity of the optical emission, as reflected by the different colors, can indicate a defect.

The above described methods suffer from several deficiencies. First, the mapping of the intensity of the optical emission on the color pallet may cause masking of defects. Consider that the optical sensor's pixel may cover a location of the IC comprising more than a single component. Thus the intensity of the optical emission at the sensor's pixel is a weighted sum of the intensities of the optical emissions from the plurality of components covered by the pixel; which is then mapped to a bin represented by a first color. Thus, if a single component is defective, the contribution on the change in the intensity of the optical emission of the defective component may not be sufficient to increase the weighted sum of the intensities of the plurality of components so that the weighted sum would be mapped to a different bin, cf. FIG. 5b, infra. Furthermore, the visual comparison of the picture taken on the IC under test and on the IC considered without defects may not reveal defects because an eye may not be sensitive enough to distinguish minor changes in colors. Additionally, defects have a threshold at which they appear and typically have a nonlinear emission response to applied voltage variations. However, such defects cannot be discerned from a single picture. Even if the operator were to take additional pictures, e.g., at maximum and minimum tolerances for the voltage a specified by a data sheet of the IC, the three observation points would not necessarily discern such a defect because the defect may lie between the voltages, cf. FIG. 5, infra.

There is; therefore, a need in the art to address at least some of the deficiencies identified above.

### SUMMARY

In one aspect of the disclosure, an apparatus and a method for identifying the location of abnormal emission on integrated circuits according to appended independent claims is disclosed. Additional aspects are disclosed in dependent claims.

### BRIEF DESCRIPTION OF THE DRAWINGS

The foregoing aspects described herein will become more readily apparent by reference to the following description when taken in conjunction with the accompanying drawings wherein:

FIG. 1 depicts a conceptual block diagram for a system in accordance with aspects of this invention;

FIG. 2 depicts a data acquisition operation of the system of FIG. 1;

FIG. 3 depicts a data processing operation of the system of FIG. 1;

FIGS. 4a and 4b depict exemplary plots of emission intensity as a function of a voltage; and

FIGS. 5a-c depict defect scenarios as disclosed in reference to FIGS. 4a and 4b, as evaluated by an observer.

### DETAILED DESCRIPTION

Various aspects of the present invention will be described herein with reference to drawings that are schematic illustrations of idealized configurations of the present invention. As such, variations from the shapes of the illustrations as a result, for example, manufacturing techniques and/or tolerances, are to be expected. Thus, the various aspects of the present invention presented throughout this disclosure should not be construed as limited to the particular shapes of elements (e.g., regions, layers, sections, substrates, etc.) illustrated and described herein but are to include deviations in shapes that result, for example, from manufacturing. By way of example, an element illustrated or described as a rectangle may have rounded or curved features and/or a gradient concentration at its edges rather than a discrete change from one element to another. Thus, the elements illustrated in the drawings are schematic in nature and their shapes are not intended to illustrate the precise shape of an element and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

Various disclosed aspects may be illustrated with reference to one or more exemplary configurations. As used herein, the term “exemplary” means “serving as an example, instance, or illustration,” and should not necessarily be construed as preferred or advantageous over other configurations disclosed herein.

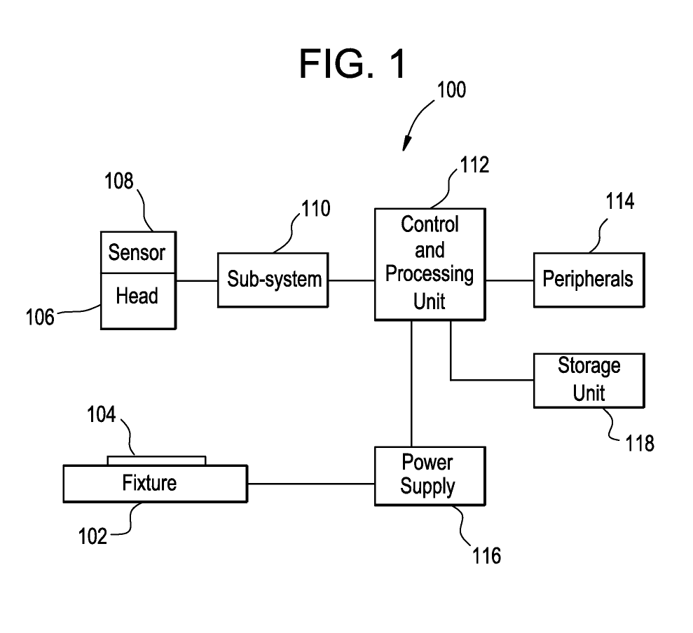

FIG. 1 depicts a block diagram for a system 100 in accordance with aspects of this invention. A fixture 102 accepts an exposed chip 104 of an IC under test. A head 106 comprising a sensor 108 and, optionally, the sensor' 108 supporting sub-systems (not shown), is disposed above the fixture 102 so that an emission from the chip 104 may be captured. The sensor 108 may comprise a raster sensor, i.e., a sensor whose active area is divided into discrete pixels, or an analog sensor. The supporting sub- systems may comprise electronic and mechanical components enabling function of the head 106, e.g., optics, circuitry for amplifying the sensor's 108 signal, circuitry for interfacing the sensor 108 to the other parts of the system 100, circuitry for creating a raster image form an analog sensor, digitizing the signal produced by the sensor 108, and other supporting sub-systems known to a person skilled in the art. Although only a single head 106 is shown in FIG. 1, a person skilled in the art would understand that the system 100 may comprise multiple heads, e.g., a head for sensing emission in a near-infrared portion of a spectrum, a head for sensing emission in an infrared portion of a spectrum, a head for sensing emission in a visible portion of a spectrum, and other heads known to such a person.

A sub-system 110, communicatively coupled to the head 106, comprises electronic and mechanical components enabling functions and/or control of functions necessary for the operation of the head 106. Such functions may comprise e.g., focusing the sensor 108 on the area of the chip 104, movement of the head 106 over the fixture 102 if the senor 108 cannot capture the entire area of the chip 104, disposing a specific head in a case of multi-head arrangement over the fixture 104, and other functions known to a person skilled in the art. The sub-system 110 further provides an interface (not shown) communicatively connected with an interface (not shown) on a control and processing unit 112, which provides control instructions to the sub-system 110.

The control and processing unit 112 is additionally communicatively connected through an interface (not shown) with peripherals 114, serving as an interface of the system 100 with an operator (not shown), and a storage unit 108. Thus the peripherals may comprise input devices, e.g., keyboard, mouse, and output device, e.g., video display, printer. The control and processing unit 112 is further communicatively connected through an interface (not shown) with a power supply 116, which provides power to the chip 104 by means of the fixture 102.

A person skilled in the art will understand that the block diagram of FIG. 1 describes a conceptual arrangement, which may differ from a specific implementation. Thus, by means of an example, the electronic and mechanical components of the sensor 108 supporting sub-systems may be partially or fully integrated within the sub-system 110 and mutatis mutandis, the electronic and mechanical components be partially or fully integrated within the head 106. Likewise, the control and the processing functions of the the control and processing unit 112 may be separated into at least two entities. Additionally, although three interfaces on the control and processing unit 112 are disclosed, it is understood that they may be implemented either as a single interface or a plurality of interfaces. Furthermore, although the storage unit 118 is depicted as communicatively connected to the control and processing unit 112 the storage unit 118 may be implemented as being also or alternatively communicatively connected to the sub-system 110. Alternatively, the storage unit 108 may be integrated in the sub-system 110, the control and processing unit 112, or both.

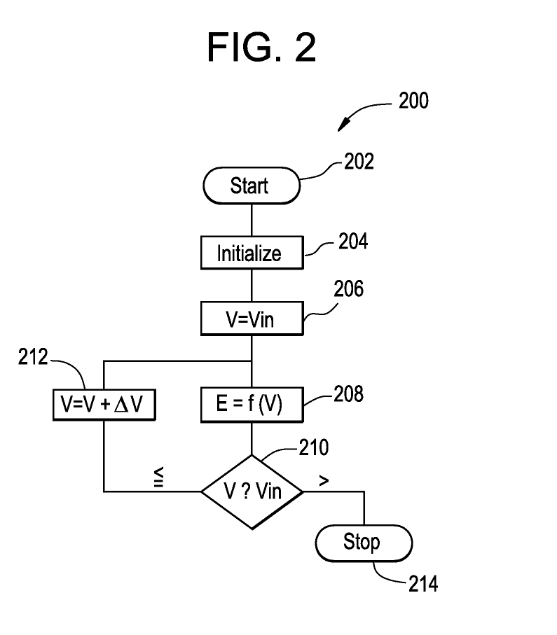

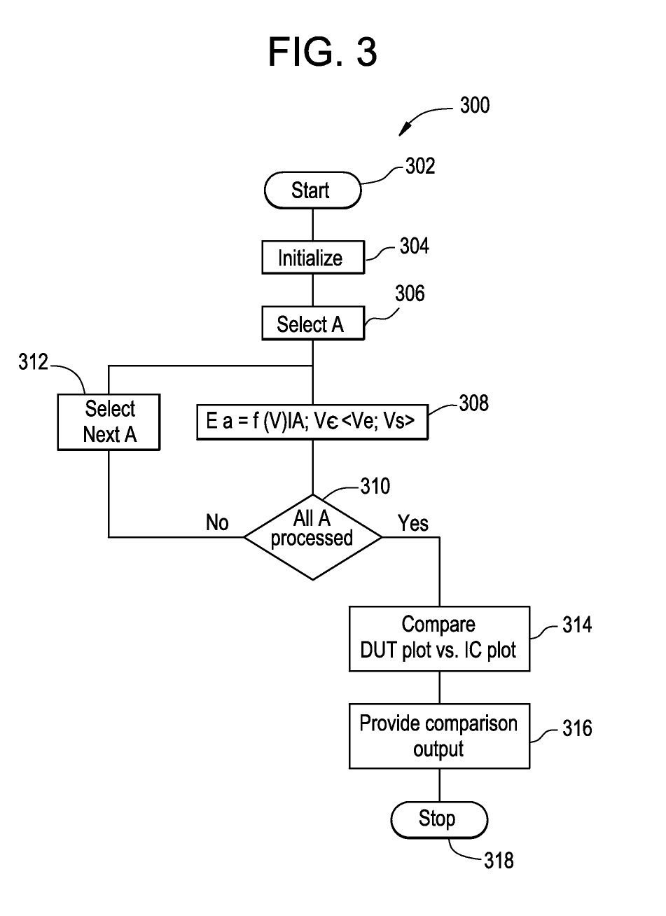

The operation of the system 100 of FIG. 1 is disclosed in reference to FIG. 2 and FIG. 3. A person skilled in the art will understand that the operation of the system 100 is disclosed in two separate operations, data acquisition operation 200 of FIG. 2 and data processing operation 300 of FIG. 3, merely for the purposes of clarity of explanation of the inventive concepts. However, a specific implementation may combine the two processes. Thus, by means of an example, the data processing operation 300, e.g. the generation of the plots of emission as a function of a voltage may be initiated during the data acquisition operation 200. Similarly, the initialization, formally separated into steps 202 and 302, may be carried out in a single step.

The data acquisition operation 200 of the system 100 of FIG. 1 is disclosed in reference to FIG. 2. The operation starts in step 202 and proceeds to step 204.

In step 204, after the chip 102 is secured in the fixture 104, the system 100 is initialized. The initialization includes any actions necessary to bring the system 100 to operational status, including, but not being limited to, applying power, performing self-checks, positioning the head 106 over the fixture, focusing the sensor 108 on the chip 104, and other actions known to a person skilled in the art. The operation proceeds to step 206.

In step 206, the control and processing unit 112 commands the power supply 116 to generate a minimum voltage, Vₘᵢₙ, and provide a voltage V=Vₘᵢₙ to the chip 102. The minimum voltage Vₘᵢₙ is typically set to zero volts for an IC with a unipolar power supply, or the maximum negative voltage per the IC's specification for an IC with a bipolar power supply. However, a person skilled in the art will understand that other criteria may be used. By means of an example, such a criterion may be measurement consideration. Thus when an initial measurement of a particular IC is performed, the Vₘᵢₙ is set to zero volts for an IC with a unipolar power supply, or the maximum negative voltage per the IC's specification for an IC with a bipolar power supply. Should testing of a plurality of the particular IC result in no defects occurring below a certain voltage, the Vₘᵢₙ may be set to this voltage. Another exemplary criterion may comprise physical characteristics of the devices comprising the IC. Thus, should a particular IC comprise only transistors, the defect is likely to occur about the voltage when the transistors transition from inactive to active region. Therefore, should testing of a plurality of the particular IC reveal that all defects occur about the transition voltage, the Vₘᵢₙ may be set below the transition voltage. The operation proceeds to step 208.

In step 208, the control and processing unit 112 commands the sensor 108 to record the intensity of emission E caused by a current due to the voltage V from the chip 102, i.e., E=f(V). Because as explained supra, the emission image recorded by the sensor 108 is eventually digitized, the plurality of tuples {V;E} corresponding to the plurality of pixels of the emission image is stored at the storage unit 108 for later processing, or provided to the control and processing unit 112 for parallel processing. The operation proceeds to step 210.

In step 210, the control and processing unit 112 compares the previous voltage provided to the chip 104 to a maximum voltage Vₘₐₓ. The maximum voltage Vₘₐₓ is typically set to the maximum operating voltage per the IC specification. However, a person skilled in the art will understand that other criteria, e.g., based on measurement consideration or physical characteristics of the devices comprising the IC, similar to the criteria for setting Vₘᵢₙ as disclosed above. In any event, the maximum voltage, Vₘₐₓ, must not exceed the maximum operating voltage per the IC specification. If the previous voltage V is less than or equal to the maximum voltage, Vₘₐₓ, the operation proceeds to step 212, otherwise, the operation proceeds to step 214.

In step 212, the control and processing unit 112 commands the power supply 116 to increase the previous voltage by an increment ΔV and provide the increased voltage to the chip 102. The increment voltage ΔV is selected to provide enough measurement data. One criterion for the selection of ΔV is that the probability that a defect occurs between two measurement data is negligible. The term negligible is understood to be dependent of test performed. Thus when an initial measurement of a particular IC is performed, the ΔV is set to a small value, typically 1 to 2% of Vₘₐₓ. After testing of a plurality of the particular ICs, the ΔV may be adjusted to a higher value when defect is demonstrated over several measurement data, or to a lower value, if a defect, demonstrated by other testing methods, is not demonstrated in the measurement data. A person skilled in the art will understand that the number of measurement data must be sufficient for a statistical comparison, if performed, as described infra. The operation proceeds to step 208.

In step 214, the data acquisition operation stops, because the processing unit 112 has acquired, i.e., measured, emission intensity for each of a plurality of voltages at each pixel in the emission image of the chip 102 of the IC.

The data processing operation 300 by the control and processing unit 112 is disclosed in reference to FIG. 3. While the data acquisition operation was carried out at the pixel level, the data processing operation may be carried out at an area level, i.e., a subset of all the pixels comprising the image, including a single pixel. The operation starts in step 302 and continues in step 304.

In step 304, the control and processing unit 112 initializes parameters needed for image processing. The parameter initialization includes any parameters necessary for the selected data processing. By means of an example, such parameter may include but not be limited to selecting a start voltage Vₛ and an end voltage Vₑ, selecting the area at which the processing is to be carried out; selecting standards for comparison, and other parameters known to a person skilled in the art. The operation proceeds to step 306.

In step 306, an area A of the emission image is selected. The data processing operation continues in step 308.

In step 308, the control and processing unit 112 generates a plot of emission intensity as a function of the voltages selected during the initialization phase, for the area A in the emission image. Should the area A be greater than a single pixel, emission intensities for each pixel comprising the area A are averaged for each one of the plurality of the selected voltages. The plot is then generated from the averaged emission intensities as a function of the plurality of the selected voltages, i.e., Ē=f(V)|A, V <Vs;Ve>. A person skilled in the art will understand that should the area A be equal to a single pixel, no averaging is necessary, i.e., E 32 f(V)|A; V <Vs;Ve>. To avoid unnecessary repetition and possible confusion, the averaged and non-averaged emission intensity will be summarily referred to as “emission intensity Ea,” unless a distinction needs to be made. Because the emission intensity Ea is proportional to the current caused by the applied voltage, V, the generated plot corresponds to a curve tracer plot of current versus voltage that a curve tracer produces. The data processing operation proceeds into step 310.

In step 310, the control and processing unit 112 ascertains whether all of the plurality of areas selected during the initialization phase were processed, in other words, whether the plot of the emission intensity Eₐ as a function of the applied voltage V was generated for all the areas selected during the initialization phase. If less than all areas were processed, the data processing operation proceeds to step 312, otherwise, the data processing operation proceeds to step 314.

In step 312, next area A from the plurality of areas selected during the initialization phase is selected. The data processing operation proceeds into step 308.

In step 314, the control and processing unit 112 compares the emission intensity versus voltage plot of the chip 108 of the IC under test (DUT plot) with the emission intensity versus voltage plot of a chip of an IC considered without defects (IC plot). A person skilled in the art will understand that the term compare does not mean overlaying the plot of the emission intensity as a function of voltage of the chip of the IC under test with the plot of the emission intensity as a function of voltage of a chip of an IC considered without defects, i.e., comparing emission intensity of the chip under test with the emission intensity of a chip of an IC considered without defects at each of the voltages; but may comprise comparison of statistics, e.g., mean, sigma, maximum, minimum, and the like, evaluated from the plot of the emission intensity as a function of voltage of the chip under test with the plot of the emission intensity as a function of voltage of a chip of a good IC. As discussed above, abnormal changes in an emission at a given area as compared to an emission in a corresponding area of an IC considered without defects can indicate a location of a defect.

It is understood that step 314 may be carried out automatically with comparison parameters being set during initialization in step 304. Alternatively, step 314 may be carried out by interactive process between the control processing unit 112 and the operator of the system 100, via the peripherals 114. The data processing operation proceeds into step 316.

In step 316, the output of the comparison is provided, i.e., the output is displayed by means of the peripherals 114 and or saved for further processing. The data processing operation proceeds into step 318.

In step 318, the data processing operation stops.

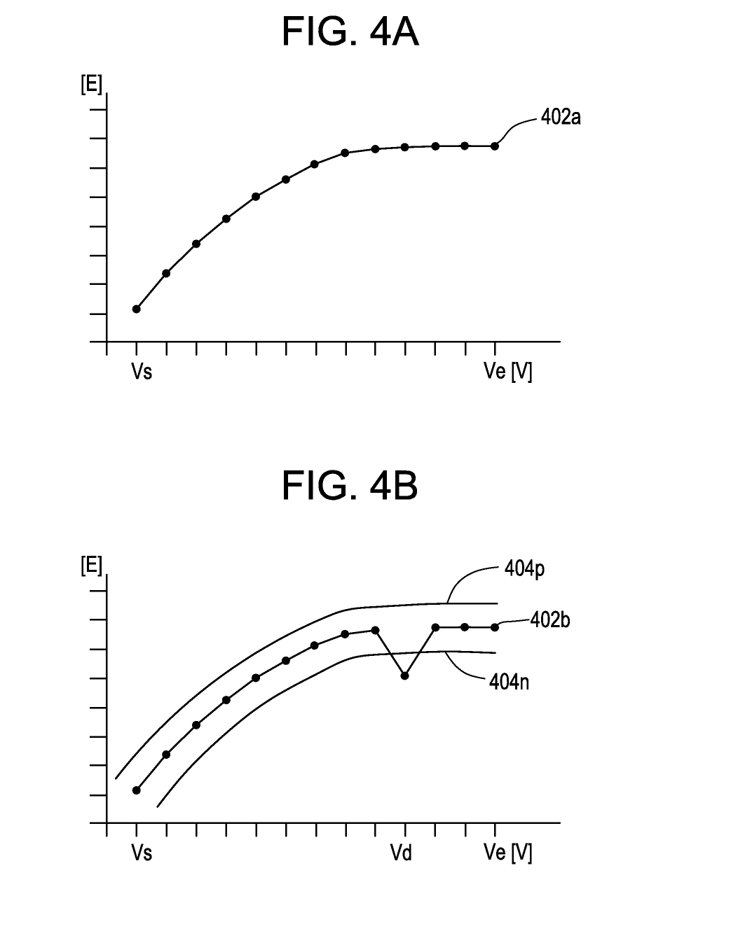

A person skilled in the art will understand that the above-disclosed aspects constitute significant improvement over the prior art process for emission analyses because the plot reveals subtle differences in emission intensity more effectively the operator ascertaining the same differences changes by an eye observation. To further elaborate on this point, consider, FIG. 4, depicting an exemplary plot of emission intensity as a function of a voltage.

FIG. 4a depicts a plot of emission intensity as a function of a voltage 402a for an area corresponding to a location on an IC considered without defects. FIG. 4b depicts a plot of emission intensity as a function of a voltage 402b for an area corresponding to a location on an IC under test, with a positive tolerance threshold 404p and a negative tolerance threshold 404n. The tolerance region is determined as maximal difference between a magnitude of emission intensity on the plot on an IC under test and a magnitude of emission intensity on the plot on an IC considered without defects. Because the measured emission intensity at voltage V_{d} is less than the negative tolerance threshold 404n, there is a defect at the location on the IC corresponding to the area.

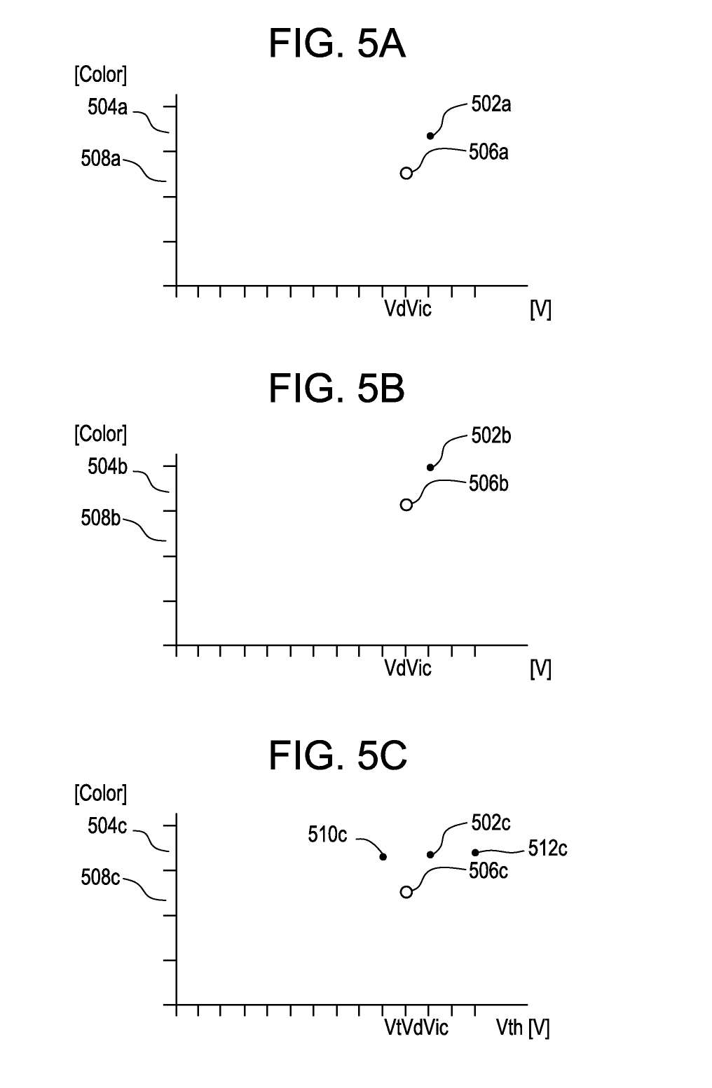

FIGS. 5a-c depict the same defect scenario as disclosed in reference to FIG. 4 as evaluated by an observer.

FIG. 5a depicts the area, containing the defect, as selected by the imaging process in a static picture of the IC measured at voltage, V_{ic}. The area reflects the intensity of the optical emission 502a mapped on a color 504a. However, because the defect manifests itself as a different emission intensity 506a at voltage, V_{d}, the observer will not detect the defect. Only if the static picture of the IC is measured at voltage V_{d} may be the defect detected because, as depicted in FIG. 5a the emission intensity 506a at voltage V_{d} is mapped on a color 508a, consequently, the observer may be able to distinguish the two different colors. However, this does not need to be the case as depicted in FIG. 5b, where the same difference in emission intensities 504b and 506b measured at voltage V_{ic} respective voltage V_{d} is mapped on the same color 502b.

Taking two additional measurements, as sometimes done, may not improve the situation as depicted in FIG. 5c. A person skilled in the art will understand that the observer will see three different static pictures measured at voltages Vₜ₁, V_{ic}, and Vₜₕ. The first picture will contain the area, containing the defect, as selected by the imaging process in a static picture of the IC measured at voltage Vₜ₁. The area reflects the intensity of the optical emission 510c mapped on a color 504c. The second picture will contain the area, containing the defect, as selected by the imaging process in a static picture of the IC measured at voltage V_{ic}. The area reflects the intensity of the optical emission 502c mapped on a color 504c. The third picture will contain the area, containing the defect, as selected by the imaging process in a static picture of the IC measured at voltage Vₜₕ. The area reflects the intensity of the optical emission 512c mapped on a color 504c. FIG. 5c, depicts the area, containing the defect, as selected by the imaging process in the three different static picture of the IC in one plot for clarity of explanation together with the defect as an emission intensity 506c at voltage V_{d} mapped at color 508c. It is immediately understood from observation of FIG. 5c, that, because the defect manifests itself as a different emission intensity 506a at voltage V_{d}, the observer will not detect the defect from the static pictures measured at voltages Vₜ₁, V_{ic}, and Vₜₕ.

As in the previous case, only if one of the static pictures of the IC is measured at voltage V_{d} may be the defect detected because, as depicted in FIG. 5c the emission intensity 506c at voltage V_{d} is mapped on a color 508c, consequently, the observer may be able to distinguish the two different colors. However, this does not need to be the case as if the same difference in emission intensities 504c and 506c measured at voltage V_{ic} respective voltage V_{d} are mapped on the same color, i.e., 502c or 508c.

Additionally, even if a defect is detected, the human eye may not have adequate spatial resolution to distinguish the intensity of one pixel surrounded by pixels of a different intensity displayed on high resolution displays. A single defective transistor can be represented by just one pixel and be missed by an operator viewing a screen.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for identifying a location of abnormal emission on integrated circuits comprising:
measuring an emission intensity for each of a plurality of voltages for each pixel in an emission image of an integrated circuit;
generating a plot of the measured emission intensities as a function of the plurality of voltages for each area in the emission image of the integrated circuit;
determining differences in emission intensities of the generated plot for a selected area compared to a plot for a corresponding area known to have no abnormal emission; and
identifying location of abnormal emission corresponding to the selected area the detected difference of which exceeds a pre-determined threshold.

2. The method as claimed in claim 1 wherein measuring an emission intensity for each of a plurality of voltages for each pixel in an emission image of an integrated circuit comprises:
selecting a plurality of voltages; and
sensing for each pixel an emission intensity for each of the plurality of voltages.

3. The method as claimed in claim 1 wherein the generating a plot of the measured emission intensities as a function of the plurality of voltages for each area in the emission image of the integrated circuit comprises:
averaging emission intensities for each pixel comprising an area for each one of the plurality of voltages; and
generating a plot of the averaged emission intensities as a function of the plurality of voltages for each area.

4. The method as claimed in claim 1 wherein the determining differences in emission intensities of the generated plot for a selected area compared to a plot for a corresponding area known to have no abnormal emission comprises:
determining for each of the plurality of voltages a difference between an emission intensity in the generated plot at the selected area and an emission intensity in the plot for a corresponding area known to have no abnormal emission.

5. The method as claimed in claim 4 wherein the identifying location of abnormal emission corresponding to the selected area the detected difference of which exceeds a pre-determined threshold comprises:
identifying location of abnormal emission corresponding to the selected area the detected difference of which exceeds a pre-determined threshold for at least one of the plurality of voltages.

6. The method as claimed in claim 1 wherein the determining differences in emission intensities of the generated plot for a selected area compared to a plot for a corresponding area known to have no abnormal emission comprises:
carrying out a statistical analysis of the generated plot for the selected area in the emission image of the integrated circuit;
carrying out the statistical analysis of a plot for a corresponding area known to have no abnormal emission;
determining differences between parameters of the statistical analyses.

7. The method as claimed in claim 6 wherein the identifying location of abnormal emission corresponding to the selected area the detected difference of which exceeds a pre-determined threshold comprises:
identifying location of abnormal emission corresponding to the selected area the detected difference between the parameters of the statistical analyses exceeds a pre-determined threshold for at least one of the parameters.

8. The method as claimed in claims 1 further comprising:
carrying the steps of measuring, generating, determining, and identifying by a control and processing unit.

9. An apparatus for identifying a location of abnormal emission on integrated circuits comprising:
a processing unit configured to
access measurements of an emission intensity for each of a plurality of voltages for each pixel in an emission image of an integrated circuit;
generate a plot of the measured emission intensities as a function of the plurality of voltages for each area in the emission image of the integrated circuit;
determine differences in emission intensities of the generated plot for a selected area compared to a plot for a corresponding area known to have no abnormal emission; and
identify location of abnormal emission corresponding to the selected area the detected difference of which exceeds a pre-determined threshold.

10. The apparatus as claimed in claim 9, wherein the processing unit accesses the measurements of an emission intensity for each of a plurality of voltages for each pixel in an emission image of an integrated circuit from a storage media.

11. The apparatus as claimed in claim 9 the processing unit being further configured to
select a plurality of voltage values; and
provide the plurality of voltage values.

12. The apparatus as claimed in claim 11 further comprising:
an interface unit communicatively connected to the processing unit, the interface unit being configured to:
output the plurality of voltage values; and
receive measurements of the emission intensity for each of the plurality of voltages for each pixel.

13. The apparatus as claimed in claim 12 wherein the interface unit is further configured to:
provide to the processing unit the measurements of the emission intensity for each of the plurality of voltages for each pixel.

14. The apparatus as claimed in claim 9 wherein the processing unit generates a plot of the measured emission intensities by being configured to:
average emission intensities for each pixel comprising an area for each one of the plurality of voltages; and
generate a plot of the averaged emission intensities as a function of the plurality of voltages for each area.

15. The apparatus as claimed in claim 9 wherein the processing unit determines differences in emission intensities of the generated plot for a selected area compared to a plot for a corresponding area known to have no abnormal emission by being configured to:
determine for each of the plurality of voltages a difference between an emission intensity in the generated plot at the selected area and an emission intensity in the plot for a corresponding area known to have no abnormal emission.

16. The apparatus as claimed in claim 15 wherein the processing unit identifies location of abnormal emission corresponding to the selected area the detected difference of which exceeds a pre-determined threshold by being configured to:
identify location of abnormal emission corresponding to the selected area the detected difference of which exceeds a pre-determined threshold for at least one of the plurality of voltages.

17. The apparatus as claimed in claim 9 wherein the processing unit determines differences in emission intensities of the generated plot for a selected area compared to a plot for a corresponding area known to have no abnormal emission by being configured to:
carry out a statistical analysis of the generated plot for the selected area in the emission image of the integrated circuit;
carry out the statistical analysis of a plot for a corresponding area known to have no abnormal emission;
determine differences between parameters of the statistical analyses.

18. The apparatus as claimed in claim 17 wherein the processing unit identifies location of abnormal emission corresponding to the selected area the detected difference of which exceeds a pre-determined threshold by being configured to:
identify location of abnormal emission corresponding to the selected area the detected difference between the parameters of the statistical analyses exceeds a pre-determined threshold for at least one of the parameters.

19. A computer-program product for identifying a location of abnormal emission on integrated circuits, comprising:
a machine-readable medium comprising instructions executable to
access data comprising measurements of an emission intensity for each of a plurality of voltages for each pixel in an emission image of an integrated circuit;
generate a plot of the measured emission intensities as a function of the plurality of voltages for each area in the emission image of the integrated circuit;
determine differences in emission intensities of the generated plot for a selected area compared to a plot for a corresponding area known to have no abnormal emission; and
identify location of abnormal emission corresponding to the selected area the detected difference of which exceeds a pre-determined threshold.

20. The computer-program product as claimed in claim 19 wherein the a machine-readable medium further comprises instructions executable to:
select a plurality of voltage values;
provide the plurality of voltage values.

21. The computer-program product as claimed in claim 19 wherein the machine-readable medium executable instructions to generate a plot of the measured emission intensities as a function of the plurality of voltages for each area in the emission image of the integrated circuit comprise instructions executable to:
average emission intensities for each pixel comprising an area for each one of the plurality of voltages; and
generate a plot of the averaged emission intensities as a function of the plurality of voltages for each area.

22. The computer-program product as claimed in claim 19 wherein the machine-readable medium executable instructions to determine differences in emission intensities of the generated plot for a selected area compared to a plot for a corresponding area known to have no abnormal emission comprise instructions executable to:
determine for each of the plurality of voltages a difference between an emission intensity in the generated plot at the selected area and an emission intensity in the plot for a corresponding area known to have no abnormal emission.

23. The computer-program product as claimed in claim 22 wherein the machine-readable medium executable instructions to identify location of abnormal emission corresponding to the selected area the detected difference of which exceeds a pre-determined threshold comprise instructions executable to:
identify location of abnormal emission corresponding to the selected area the detected difference of which exceeds a pre-determined threshold for at least one of the plurality of voltages.

24. The computer-program product as claimed in claim 19 wherein the machine-readable medium executable instructions to determine differences in emission intensities of the generated plot for a selected area compared to a plot for a corresponding area known to have no abnormal emission comprise instructions executable to:
carry out a statistical analysis of the generated plot for the selected area in the emission image of the integrated circuit;
carry out the statistical analysis of a plot for a corresponding area known to have no abnormal emission;
determine differences between parameters of the statistical analyses.

25. The computer-program product as claimed in claim 24 wherein the machine-readable medium executable instructions to identify location of abnormal emission corresponding to the selected area the detected difference of which exceeds a pre-determined threshold comprise instructions executable to:
identify location of abnormal emission corresponding to the selected area the detected difference between the parameters of the statistical analyses exceeds a pre-determined threshold for at least one of the parameters.
